(19) United States
(12) Patent Application Publication
(10) Pub. No.: US 2010/0265093 A1
(43) Pub. Date: Oct. 21, 2010

(54) METHOD OF AUTOMATICALLY GENERATING FINGERPRINT DATABASE FOR AN INDOOR WIRELESS LOCATION

(75) Inventors: Seong Yun Cho, Daejeon (KR); Byung Doo Kim, Daejeon (KR); Young Su Cho, Seoul (KR); Wan Sik Choi, Daejeon (KR); Jong-Hyun Park, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTITUTE, DAEJEON (KR)

(21) Appl. No.: 12/741,937

(22) PCT Filed: Aug. 29, 2008
(86) PCT No.: PCT/KR2008/005085

§ 371 Date: May 7, 2010

(30) Foreign Application Priority Data
Dec. 7, 2007 (KR) 10-2007-0127018

(51) Int. Cl. G08B 5/22

(52) U.S. Cl. 340/825.49

(57) ABSTRACT

The present invention relates to a method of automatically generating a fingerprint database for indoor wireless location. For this purpose, the present invention provides a method of generating a fingerprint database that determines a method of calculating the strength of signals transmitted from a plurality of access points, calculates the strength of signals at nodes of a plurality of vertical and horizontal grids set in an indoor space, and generates a database table by using the location information about the nodes and the calculated strength of the signals. Further, the present invention provides an environment analysis tool including a communication module that performs communication between at least one of the access points and a receiving terminal, an environment analysis module that calculates the strength of a signal at a specific location by using a method of calculating strength and generates a fingerprint database table, and a fingerprint database that stores the fingerprint database table. According to the present invention, it is possible to reduce time and manpower required to build a fingerprint database, and to easily build a new fingerprint database even though an indoor structure is changed.

### TECHNICAL FIELD

The present invention relates to a method of automatically generating a fingerprint database for an indoor wireless location. Particularly, the present invention relates to a method of building a fingerprint database for an indoor location by using a wireless local area network (WLAN), an ultra wideband wireless communication (UWB), a chirp spread spectrum (CSS), Zigbee, bluetooth, and the like.

The present invention is supported by the IT R&D program of MIC/IITA [2007-F-040-01, Development of Indoor/Outdoor Seamless Positioning Technology].

### BACKGROUND ART

A location-based service (LBS) is a service that confirms current location information by using a satellite-based location confirmation receiving terminal such as a GPS, and provides various additional services, such as a navigation service, a surrounding information service, a traffic information service, a logistics monitoring-control service, a rescue request service, a crime reporting service, a location-based customer relationship management (CRM) service, and the like.

In order to provide these location-based services, it is essential to locate the location confirmation receiving terminal. However, there is a problem in that a satellite-based location confirmation receiving terminal cannot provide location information in a region having a weak satellite signal, such as a room, a tunnel, an underground parking lot, or a downtown area.

In order to solve the problem, indoor location technologies for providing location-based services in a region having a weak satellite signal, such as a room, have been researched in various ways. Particularly, there have been researched and developed various wireless location methods using wireless communication apparatuses, such as a wireless local area network (WLAN), an ultra wideband wireless communication (UWB), a chirp spread spectrum (CSS), Zigbee, and Bluetooth.

In wireless communication infrastructure-based indoor location, a distance between an access point (hereinafter, referred to as “AP”) and a receiving terminal is small, and there is a problem in that it is difficult to calculate location information at high accuracy due to signal attenuation or multipath errors caused by walls or furniture.

Further, if time is not synchronized between a plurality of APs or between an AP and a receiving terminal, it is not possible to use location methods, such as a time difference of arrival (TDoA) method of performing location estimation using difference of electric wave arrival time between two APs, and a time of arrival (ToA) method of performing location estimation using electric wave arrival time between an AP and a receiving terminal. For this reason, a location method using received signal strength indication (RSSI) from a receiving terminal should be used.

Trilateration and a fingerprint method have been used as a method of estimating the location of a receiving terminal by using received signal strength indication.

The trilateration is a method that estimates a distance between an AP and a receiving terminal by using a signal-propagation attenuation model in order to estimate a location. A fingerprint method is a method that stores the strength of a signal transmitted from each pre-measured AP in a database, receives the location information corresponding to a signal strength value when the signal strength value received from a receiving terminal is transmitted, and transmits the location information to the receiving terminal.

The above-mentioned fingerprint method has a merit in that accuracy is excellent. However, a database, which stores a relationship between location information and a signal strength value, should be built in advance in order to perform the fingerprint method. For this purpose, it is necessary to actually measure a signal from each AP in advance and to build a database.

Time and manpower are required to build the database, and there is a problem in that time and manpower are also additionally required to newly build a database when the indoor structure of a room, a tunnel, an underground parking lot, or a downtown area, is changed.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a method of automatically generating a fingerprint database that uses an environment analysis tool for indoor location estimation to reduce time and manpower required for building a database and to easily build a database even though an indoor structure is changed.

### Technical Solution

An exemplary embodiment of the present invention provides a method of generating a fingerprint database that locates a receiving terminal located in an indoor space. The method includes performing AP modeling that performs the mathematization of a method of calculating the strength of a signal transmitted from at least one of access points provided in the indoor space; setting a plurality of vertical and horizontal grids in the indoor space, and calculating the strength of a signal received from at least one of the access points at each node of the vertical and horizontal grids; and building a fingerprint database table by using location information of the node and the strength of the signal calculated for at least one of the access points.

Further, another embodiment of the present invention provides an environment analysis tool that includes a communication module, an environment analysis module, and a fingerprint database. The communication module performs communication between at least one of the access points and a receiving terminal. The environment analysis module determines a method of calculating the strength by using signal strength received from at least one of the access points by the communication module, calculates the signal strength at a specific location in the indoor space by using the method of calculating the strength, and generates a fingerprint database table used to confirm the location information of the receiving terminal. The fingerprint database stores the fingerprint database table generated by the environment analysis module.

### ADVANTAGEOUS EFFECTS

According to the present invention, since a fingerprint database is formed using minimum experimental data and simulation, it is possible to solve a problem that much measurement data should be acquired. Therefore, it is possible to obtain an advantage of reducing time and manpower required for building a database. Further, it is possible to obtain an advantage of easily building a database even though an indoor structure is changed.

### BRIEF DESCRIPTION OF THE DRAWINGS

FIG. 1 is a view schematically showing an environment analysis tool that automatically builds a fingerprint database according to an exemplary embodiment of the present invention.

FIG. 2 is a flowchart illustrating a method of automatically building a fingerprint database according to an exemplary embodiment of the present invention.

FIG. 3 is a view illustrating a method of setting a grid according to an exemplary embodiment of the present invention.

FIG. 4 is a view illustrating a method of calculating the strength of a received signal at a node selected according to an exemplary embodiment of the present invention.

FIG. 5 is a view showing a fingerprint database table that is generated according to an exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be further understood that the terms “comprise” and/or “comprising”, when used in this specification, specify the presence of stated features, integers, steps, operations, elements, and/or components, but do not preclude the presence or addition of one or more other features, integers, steps, operations, elements, components, and/or groups thereof. In addition, the terms “-er”, “-or”, and “module” described in the specification mean units for processing at least one function and operation and can be implemented by hardware components, software components, and combinations thereof.

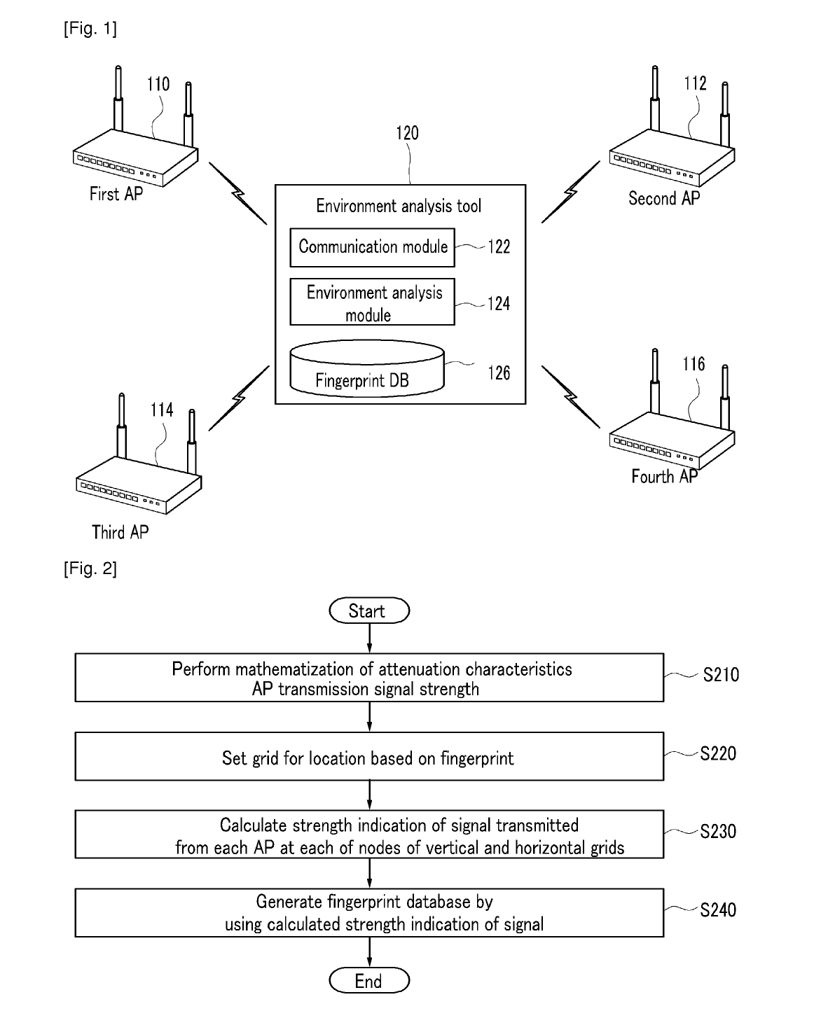

FIG. 1 is a view schematically showing an environment analysis tool that automatically builds a fingerprint database according to an exemplary embodiment of the present invention.

An environment analysis tool 120 according to an exemplary embodiment of the present invention estimates strength indication of signals, which are transmitted from a plurality of APs 110, 112, 114, and 116 provided indoors and are received by receiving terminals, on the basis of a simulation, and generates a fingerprint database table. Then, the environment analysis tool performs a function of building a fingerprint database by using the generated fingerprint database table.

For this purpose, the environment analysis tool 120 includes a communication module 122, an environment analysis module 124, and a fingerprint database 126. The communication module receives signals from the plurality of APs 110, 112, 114, and 116. The environment analysis module models APs in an indoor space, estimates the strength of the received signals in the modeled indoor space, and generates a fingerprint database. The fingerprint database stores a generated fingerprint database table.

The automatic building of a fingerprint database according to an exemplary embodiment of the present invention is performed in the environment analysis module 124 of the environment analysis tool 120.

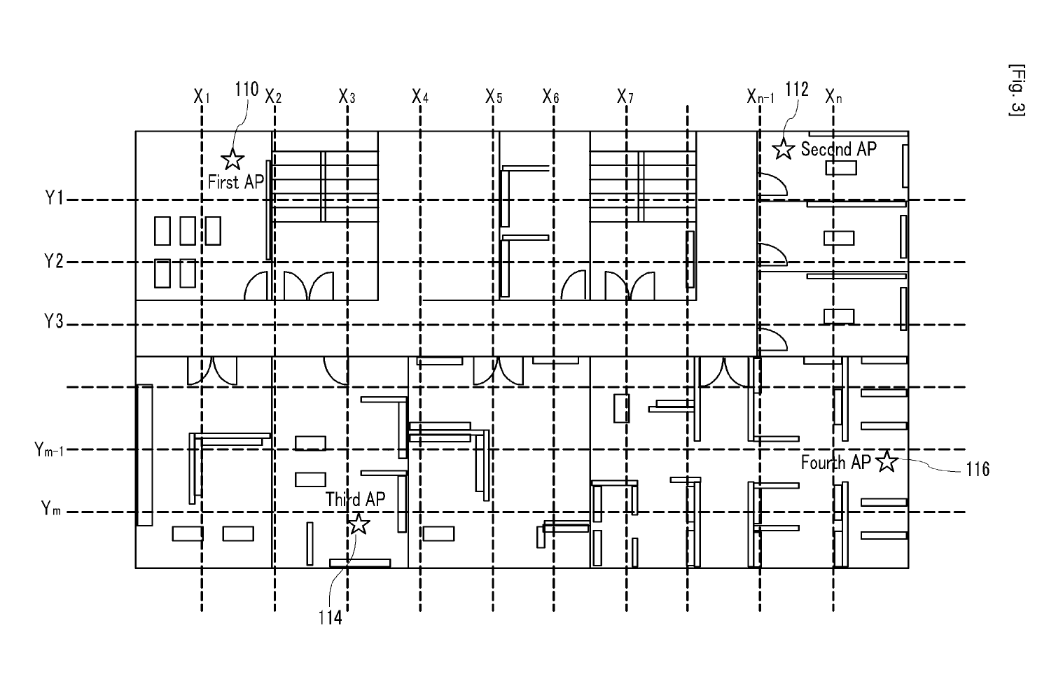

FIG. 2 is a flowchart illustrating a method of automatically building a fingerprint database according to an exemplary embodiment of the present invention.

In order to build the fingerprint database according to the exemplary embodiment of the present invention, the environment analysis module 124 performs an AP modeling operation for performing the mathematization of the attenuation characteristics of the signal strength generated while the signals transmitted from the plurality of APs 110, 112, 114, and 116 are propagated or pass through a wall.

The attenuation characteristics of the signal strength vary depending on the characteristics of infrastructures, such as WLAN, UWB, CSS, Zigbee, and Bluetooth. Therefore, the attenuation characteristics should be set to vary according to the characteristics of wireless communication infrastructures where an indoor location is to be used. Further, even in the same infrastructure, the attenuation characteristics of the signal strength vary depending on the kinds of the APs 110, 112, 114, and 116 that are to be used, the number thereof, or the communication modules of the receiving terminals thereof. Therefore, a modeling operation is performed on the AP provided in the indoor space where a location service is provided.

The above-mentioned AP modeling may be represented by Equation 1.

$$P ( r ) = P ( {r}_{0} ) - 10 {αlog}_{10} ( \frac{r}{{r}_{0}} ) - m \cdot F \qquad Equation 1$$

Here, P(r) indicates the strength of a signal received by a receiving terminal at a location that is distant from the AP by a distance r, P(r₀) indicates the strength of a signal received by a receiving terminal at a location that is distant from the AP by a reference distance r₀, α indicates a path loss coefficient, m indicates the number of walls through which the signal passes, and F indicates a wall passing attenuation coefficient.

α is a variable that should be estimated as a path loss coefficient corresponding to the attenuation of the strength of a signal while the signal is propagated through a space where obstacles are not provided or a space where inner fixtures, such as partitions, are provided. F is a coefficient corresponding to the attenuation while a signal passes through a wall. Since F varies depending on the infrastructure characteristics, F is a variable to be estimated.

Here, the reference distance r₀ may be set to an arbitrary numeral, such as 1 m, 5 m, or 10 m. Further, it is possible to acquire P(r₀), which represents the strength of a signal received at a set reference distance, by an experiment in consideration of a case where there is no obstacle between an AP and a receiving terminal.

In the following description, a reference distance will be defined as r̅₀, and the strength indication of a signal measured at the reference distance r̅₀ will be defined as P̅( r̅₀).

In order to estimate variables α and F that should be estimated in Equation 1, the environment analysis module 124, which has acquired P̅( r̅₀), acquires a signal at an arbitrary location in an indoor space, and then develops Equation 1 to the following Equation 2.

$$MX = Y \\ Where M = [ \begin{matrix}10 {log}_{10} ( \frac{{r}_{1}}{{r}_{0}} ) & {m}_{1} \\ 10 {log}_{10} ( \frac{{r}_{2}}{{r}_{0}} ) & {m}_{2} \\ ⋮ & ⋮ \\ 10 {log}_{10} ( \frac{{r}_{N}}{{r}_{0}} ) & {m}_{N}\end{matrix} ] , \\ X = [ \begin{matrix}α \\ F\end{matrix} ] , \\ and Y = [ \begin{matrix}\overline{P} ( {\overline{r}}_{0} ) - P ( {r}_{1} ) \\ \overline{P} ( {\overline{r}}_{0} ) - P ( {r}_{2} ) \\ ⋮ \\ \overline{P} ( {\overline{r}}_{0} ) - P ( {r}_{N} )\end{matrix} ] \qquad Equation 2$$

Further, N indicates the number of acquired samples and should have a value of 2 or more, rᵢ indicates a distance between a location where the i-th sample is acquired and the AP, P(rᵢ) indicates the strength of the acquired i-th sample signal, and mᵢ indicates the number of walls that exist between the acquired sample location and the AP.

Through Equation 2, it is possible to estimate X, which is composed of the variables α and F to be estimated, by a pseudo-inverse matrix of a matrix M. An estimation equation may be represented as Equation 3.

\hat{X}=(M^{T}M)⁻¹M^{T}Y Equation 3

Here, if \hat{α} and \hat{F} estimated by Equation 3 are used, the AP may be modeled by Equation 4.

$$P ( r ) = P ( {\overline{r}}_{0} ) - 10 \hat{α} {log}_{10} ( \frac{r}{{\overline{r}}_{0}} ) - m \cdot \hat{F} \qquad Equation 4$$

When an AP modeling operation is completed like Equation 4 (S210), a grid for the fingerprint-based location is set.

The grid setting may vary depending on the accuracy of location information to be served. The location accuracy varies at the fingerprint-based location, depending on the interval of the grid. Therefore, the interval of the grid is set to be narrow for the purpose of the service requiring high accuracy and is set to be wide for the purpose of the service requiring low accuracy. The interval of the grid is in inverse proportion to the size of a database, the time required for the database correlation when a received signal is located, and a calculation amount.

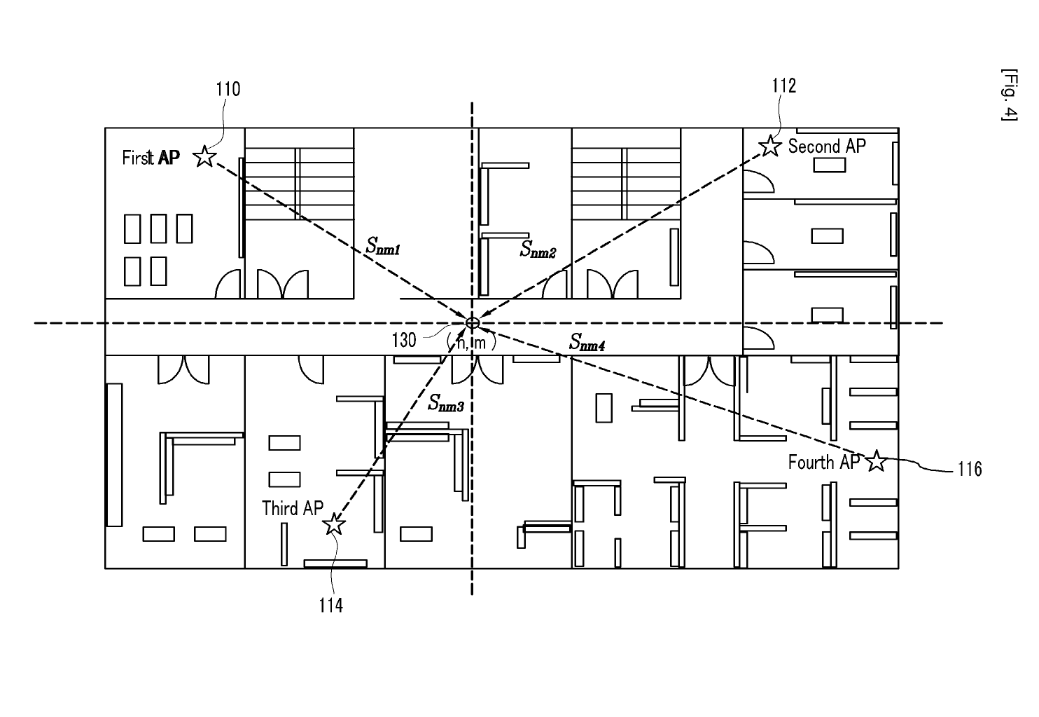

FIG. 3 is a view illustrating a method of setting a grid according to an exemplary embodiment of the present invention.

A digital map of the indoor space is required to set the grid. Further, an operation for confirming location information about the plurality of APs 110, 112, 114, and 116 provided in the indoor space is performed. The interval of the grid is determined depending on a condition such as location accuracy. Vertical grids X₁ to Xₙ that are classified into n grids at predetermined intervals, and horizontal grids Y₁ to Yₘ that are classified into m grids by predetermined intervals are shown in FIG. 3 (S220).

When the indoor space is classified into a plurality of vertical grids and the plurality of horizontal grids, the environment analysis module 124 calculates the strength of the signals transmitted from the APs at the nodes of the vertical grids and the horizontal grids.

The strength indication of the signals is estimated by Equation 4. The environment analysis module 124 selects one node of the vertical grids and the horizontal grids, and calculates the strength of a signal received from each AP at the selected node.

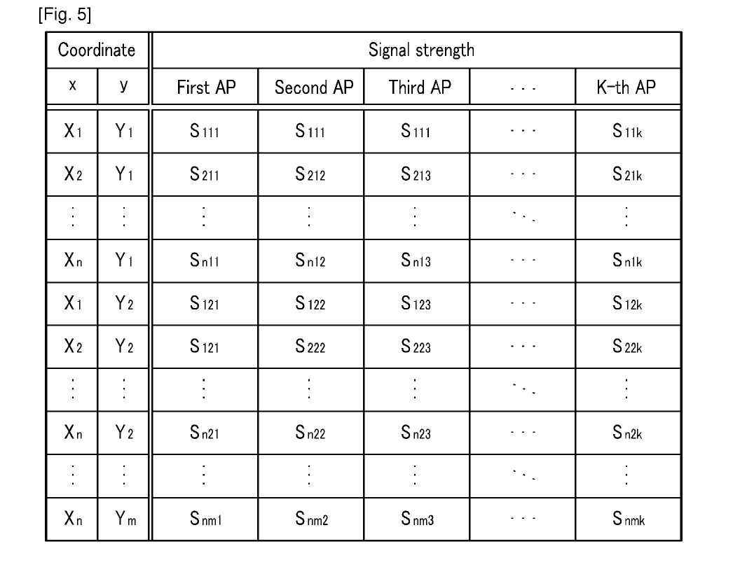

FIG. 4 is a view illustrating a method of calculating the strength of a received signal at a node selected according to an exemplary embodiment of the present invention.

When a node corresponding to a location (n, m) is selected by the environment analysis module 124 as shown in FIG. 4, the strength of the signal received from a first AP 110 by a receiving terminal located at the node corresponding to the location (n, m) is indicated by Sₙₘ₁, the strength of the signal received from a second AP 112 is indicated by Sₙₘ₂, the strength of the signal received from a third AP 114 is indicated by Sₙₘ₃, and the strength of the signal received from a fourth AP 116 is indicated by Sₙₘ₄.

If being calculated using Equation 4, the strength of the signal received from each AP may be calculated by Equation 5.

$${S}_{n m i} = P ( r ) = P ( {\overline{r}}_{0} ) - 10 \hat{α} {log}_{10} ( \frac{r}{{\overline{r}}_{0}} ) - m \cdot \hat{F} \qquad Equation 5$$

Here, i indicates an AP number. In the indoor space shown in FIG. 3, three, four, and two walls exist between the first, second, and third APs 110, 112, and 114 and the receiving terminal, respectively. Accordingly, the strength of a signal at the receiving terminal corresponding to the location (n, m) may be calculated by Equation 6.

$${S}_{n m 1} = P ( {\overline{r}}_{0} ) - 10 \hat{α} {log}_{10} ( \frac{{r}_{1}}{{\overline{r}}_{0}} ) - 3 \cdot \hat{F} \\ {S}_{n m 2} = P ( {\overline{r}}_{0} ) - 10 \hat{α} {log}_{10} ( \frac{{r}_{2}}{{\overline{r}}_{0}} ) - 4 \cdot \hat{F} \\ {S}_{n m 3} = P ( {\overline{r}}_{0} ) - 10 \hat{α} {log}_{10} ( \frac{{r}_{3}}{{\overline{r}}_{0}} ) - 2 \cdot \hat{F} \qquad Equation 6$$

Here, rᵢ indicates a distance between the i-th AP and the receiving terminal 130, and may be calculated by Equation 7.

$${r}_{i} = \sqrt{\begin{matrix}{( n - {x}_{i} )}^{2} + \\ {( m - {y}_{i} )}_{2}\end{matrix}} or {r}_{i} = \sqrt{\begin{matrix}{( n - {x}_{i} )}^{2} + \\ {( m - {y}_{i} )}_{2} + \\ {( h - {z}_{i} )}^{2}\end{matrix}} \qquad Equation 7$$

Here, (xᵢ, yᵢ, zᵢ) indicates the location information about the i-th AP, and h indicates the height information of the receiving terminal.

By the above-mentioned method, the environment analysis module 124 can calculate the strength of the signal transmitted from each AP at each of the nodes of the plurality of vertical and horizontal grids (S230).

When the strength indication of the signal at each node is calculated, the environment analysis module 124 generates a fingerprint database table by using node information and calculated strength indication of each signal, thereby building a fingerprint database (S240).

FIG. 5 is a view showing the fingerprint database table that is generated according to an exemplary embodiment of the present invention.

The fingerprint database table shown in FIG. 5 includes location information represented by (x, y), and strength indication of a signal received from each AP at each location. Here, S_{nmK} represented by the received signal information indicates the strength of the signal received from the k-th AP at the location (n, m).

The fingerprint database table shown in FIG. 5 represents the strength of the received signal in a two-dimensional space that is represented by (x, y). However, when the fingerprint database table according to the exemplary embodiment of the present invention is generated, the location information may be represented by location information in a three-dimensional space that is represented by (x, y, z).

The environment analysis tool 120 may automatically build a fingerprint database by using the fingerprint database table that is generated as described above, and can accurately locate the receiving terminal in the indoor space by using the built fingerprint database.

The above-mentioned exemplary embodiments of the present invention are not embodied only by a method and apparatus. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of generating a fingerprint database that locates a receiving terminal located in an indoor space, the method comprising:
performing AP modeling that performs the mathematization of a method of calculating the strength of a signal transmitted from at least one of access points provided in the indoor space;
setting a plurality of vertical and horizontal grids in the indoor space, and calculating the strength of a signal received from at least one of the access points at each node of the vertical and horizontal grids; and
building a fingerprint database table by using location information of the node and the strength of the signal calculated for at least one of the access points.

2. The method of claim 1, wherein in the performing of the AP modeling, the mathematization of the method of calculating the strength of the signal is performed using the strength of a reference signal used for the AP modeling, a reference distance where the reference signal is calculated, a distance between the receiving terminal and the access point, a path loss coefficient (where the path loss coefficient indicates a variable corresponding to the attenuated strength of the signal while the signal is propagated through the indoor space), the number of obstacles through which the signal passes between the access point and the receiving terminal, an obstacle passing attenuation coefficient (where the obstacle passing attenuation coefficient indicates a variable corresponding to the attenuated strength of the signal while the signal passes through the obstacles.

3. The method of claim 2, wherein the strength of the reference signal is acquired at the reference distance by an experimental value considering a case where there is no obstacle between the access point and the receiving terminal.

4. The method of claim 3, wherein the path loss coefficient and the obstacle passing attenuation coefficient are determined by comparing the strength of a reference signal that is acquired at the reference distance by the experimental value, with the signal strength calculated at the reference distance by the mathematized method of calculating the strength.

5. The method of claim 1, wherein, in the calculating of the strength of the signal, the intervals of the vertical and horizontal grids are set to be narrow in order to provide a service requiring high-accuracy location information or are set to be wide in order to provide a service requiring low-accuracy location information.

6. The method of claim 2, wherein, in the calculating of the strength of the signal, a distance between the receiving terminal and the access point is calculated using the location information about nodes of the vertical and horizontal grids and the method of calculating the strength is calculated using the calculated distance, so that the strength of the signal received from each access point is calculated at the node.

7. An environment analysis tool comprising:
a communication module that receives a signal transmitted from at least one of access points provided in an indoor space;
an environment analysis module that determines a method of calculating the strength by using signal strength received from at least one of the access points by the communication module, calculates the signal strength at a specific location in the indoor space by using the method of calculating the strength, and generates a fingerprint database table used to confirm the location information of the receiving terminal; and
a fingerprint database that stores the fingerprint database table generated by the environment analysis module.

8. The environment analysis tool of claim 7, wherein the environment analysis module has:
an AP modeling function that determines the method of calculating the strength by using the signal strength received from at least one of the access points;
a grid setting function that sets a plurality of vertical and horizontal grids in the indoor space;
a received signal calculation function that calculates the strength of the signal at each node of the vertical and horizontal grids (where the signal strength is the strength of each signal received from at least one of the access points) by using the method of calculating the strength; and
a database building function that generates a fingerprint database table by using the location information of the node and the calculated signal strength.
